(19) United States
(12) Patent Application Publication
(10) Pub. No.: US 2006/0260414 A1
(43) Pub. Date: Nov. 23, 2006

(54) Test body clamping device in a rheometer

(75) Inventor: Wolfgang Platzek, Karlsruhe (DE)

Correspondence Address: Lichti + Partner GbR;Patentanwalte, Postfach 41 07 60, Karlsruhe, D-76207, DE

(73) Assignee: Thermo Electron (Karlsruhe) GmbH, Karlsruhe (DE)

(21) Appl. No.: 11/417,173

(22) Filed: May 4, 2006

(30) Foreign Application Priority Data
May 6, 2005 (DE) 102005021121.6

(51) Int. Cl. G01N 3/02

(52) U.S. Cl. 73/856

(57) ABSTRACT

A test body clamping device in a rheometer comprises two clamping jaws between which a test body can be clamped, and an operating device for moving the clamping jaws towards and away from each other. The invention provides that each clamping jaw is pivotably disposed about an axis, wherein the axes extend parallel to each other and parallel to a clamping surface of the respective clamping jaw. The clamping jaws moreover have an associated common drive part for exerting a drive force onto both clamping jaws, which produces a synchronized pivoting motion of both clamping jaws, wherein the clamping jaws are subjected, in their clamped position, to the action of a common clamping force element, in particular a clamping spring.

This application claims Paris Convention priority of DE 10 2005 021 121.6 filed May 6, 2005 the complete disclosure of which is hereby incorporated by reference.

### BACKGROUND OF THE INVENTION

The invention concerns a test body clamping device in a rheometer, comprising two clamping jaws, between which a test body can be clamped, and an operating device for moving the clamping jaws towards each other.

A rheometer, in particular, a rotational rheometer is conventionally used to determine the rheological values or characteristic values of a viscous substance. The rheometer comprises a lower measuring part and an upper measuring part which can be adjusted relative to each other. The upper measuring part of a rotational rheometer can be rotated and oscillated. A sample space is formed between the measuring parts for receiving a sample of the substance to be investigated. The forces and torques generated through relative adjustment between the upper and lower measuring parts can be determined, from which the desired rheological characteristic values can be calculated.

A conventional rotational rheometer can be modified to also permit measurement of a test body which consists of a dimensionally stable, rigid material. Towards this end, one test body clamping device replaces each of the upper and lower measuring parts to clamp the test body, being investigated at both its upper and lower ends. The test body is usually cube or rod-shaped. The test body clamping devices are rotated relative to each other, thereby twisting the test body. The forces and torques between the upper and lower test body clamping devices generated through twisting are also determined, from which the desired characteristic material values can be calculated.

A conventional test body clamping device comprises a fixed contact block and a clamping block which can be adjusted by a threaded rod and whose separation from the contact block can be changed, such that the test body to be investigated can be clamped between the contact block and the clamping block. Since the adjustment path of the clamping block is relatively short, only test bodies having dimensions within a narrow range can be inserted into the clamping device. In order to also enable investigation of test bodies of other dimensions, the contact block must first be removed and exchanged for a different contact block. This procedure is time-consuming and difficult and moreover requires storage of a plurality of different contact blocks.

A rotational rheometer comprises a shaft that can rotate about a longitudinal axis and can rotate the two test body clamping devices relative to each other. When conventional test body clamping devices are used, the axis of rotation or longitudinal axis of the shaft rarely coincides with the longitudinal axis of the test body. This eccentricity generates moments which can falsify the measuring results.

The ambient conditions and, in particular, the ambient temperature must be observed during determination of the characteristic material values. It may e.g. be desirable to test the material to be investigated at predetermined ambient temperatures, e.g. at a very low or very high temperatures. For this reason, the surroundings of the test body in the rheometer can be adjusted to a desired temperature within a range of between approximately −170° C. and +700° C. As a result, the test body shrinks or expands after insertion into the test body clamping device in response to the temperature. At low temperatures, the clamping effect is reduced or even eliminated, such that the test body clamping device must be re-tightened. At very high temperatures, very large tensile forces may form in the test body clamping device as the test body expands. These very high localized forces falsify the measuring result, thereby also necessitating subsequent adjustment of the test body clamping device.

It is the underlying purpose of the invention to provide a test body clamping device in a rheometer of the above-mentioned type which facilitates clamping of test bodies having different dimensions and which holds the test body in a reliable manner even in case of temperature-related deformation.

### SUMMARY OF THE INVENTION

This object is achieved in accordance with the invention with a test body clamping device having the characterizing features of the independent claim. Each clamping jaw is thereby disposed to be pivotable about its own axis, wherein the axes extend parallel to each other and parallel to a clamping surface of the respective clamping jaw. Moreover, the clamping jaws have a common drive part which applies a drive force on the clamping jaws that causes synchronized pivoting motion of both clamping jaws. In their clamped position, the clamping jaws are subjected to the action of a common clamping force element. The clamping force element is normally a clamping spring, which is taken as an example in the further description.

When two pivotably disposed clamping jaws are used, the separation between the clamping surfaces of the clamping jaws can be changed within a relatively large range and test bodies of the most differing dimensions can therefore be received without having to modify the test body clamping device. The common drive part of the two clamping jaws ensures that the pivoting motion of the two clamping jaws is synchronized, wherein the clamping surfaces of the clamping jaws are always oriented parallel to each other. In this fashion, the full surfaces of the clamping jaws uniformly abut on opposite sides of the test body and clamp it between them. The clamping jaws are thereby preferably disposed to be symmetrical with respect to an axis of rotation of the rheometer at any pivot position, such that, during clamping, the test body is centered perpendicularly with respect to the clamping surfaces of the clamping jaws relative to the axis of rotation of the rheometer shaft.

In accordance with the invention, the test body is not retained in a positive manner at its clamped position, rather the clamping jaws are held in their clamped position in a non-positive manner using a common clamping spring.

The test body is thereby clamped with a defined clamping force. Dimensional deviations associated with temperature-related expansion or shrinking of the test body and the clamping jaws can be compensated for by the spring force of the clamping spring, so that the test body is also safely retained in this case. It has turned out that even when the geometry changes to a relatively great extent, e.g. in a range of approximately 10%, safe retention of the test body is ensured without having to re-tighten the test body clamping device.

Temperature-resistant materials and materials having good heat conducting properties should be used as materials for the test body clamping device and, in particular, for the clamping jaws. A mixture of high-temperature resistant special steel and a copper alloy are preferably used, which may also be plated with hard gold.

The clamping jaws may also be disposed to be exchangeable in order to install appropriate clamping jaws for certain materials of the test body which require e.g. a clamping surface profile or the like.

In a preferred embodiment of the invention, the clamping spring acts on the clamping jaws via the drive part which is preferably a rotatably disposed drive ring. This ensures that the spring force of the clamping spring acts uniformly and with the same magnitudes on the clamping jaws and therefore on the test body.

In a preferred embodiment of the invention, the operating device comprises an adjustment screw for clamping the clamping spring. Via the adjustment screw, a user can adjust the pre-tension with which the clamping jaws abut the test body in the clamped position. The clamping spring may be exchangeable to realize different pre-tensioning forces using different, i.e. harder or softer, clamping springs.

The closing motion of the clamping jaws towards each other is achieved by introducing a rotary motion on the drive part in a positive manner using the operating device while the clamping spring is relaxed. This rotary motion may be generated e.g. when a user adjusts the adjustment screw in such a manner that it abuts a projection of the drive part, rotating the drive part during further adjustment. The rotation of the drive part produces a synchronous pivoting motion of the clamping jaws, thereby clamping the test body with a defined pre-tension. Towards this end, the adjustment screw may comprise a peripheral groove which houses the projection of the drive part.

In a preferred further development of the invention, the adjustment screw comprises an outer helical toothing which engages, in a preferably self-locking manner, with a toothed profile of the rheometer that is rigid with respect to the frame. The toothed profile of the rheometer that is rigid with respect to the frame, may be formed, in particular, on the shaft of the rheometer or a component rigidly disposed thereon.

The adjustment screw preferably comprises an inner axial recess or bore by means of which it is seated on a bearing pin of the drive part, such that it can be freely displaced. The clamping spring may thereby be disposed inside the recess and be supported on the bearing pin and also on the bottom of the recess. This has the further advantage that the clamping spring is largely protected from external influences and, in particular, from soiling.

In a further embodiment, the clamping screw may be seated in a recess of the drive part in such a manner that it can be freely displaced, wherein the clamping spring is pushed onto the clamping screw in an axial direction and is supported on a projection or head of the clamping screw and on the drive part.

In a further development of the invention, the drive part engages the clamping jaw at its end section facing away from the respective axis in order to obtain adequate clamping using relatively small forces, and to be able to adjust the clamping path in a relatively fine manner.

Further details and features of the invention can be extracted from the following description of an embodiment with reference to the drawing.

### BRIEF DESCRIPTION OF THE DRAWING

FIG. 1 shows a perspective view of an inventive test body clamping device;

FIG. 2 shows a top view of the test body clamping device, partially in section, in accordance with a first embodiment with inserted test body at the start of the clamping process;

FIG. 3 shows the test body clamping device in accordance with FIG. 2 during the clamping process;

FIG. 4 shows the test body clamping device in accordance with FIG. 3 when the clamped position has been achieved;

FIG. 5 shows the test body clamping device in accordance with FIG. 4 after exerting the spring clamping force onto the test body;

FIG. 6 shows a top view of a test body clamping device, partially in section, in accordance with a second embodiment with inserted test body and at the start of the clamping process;

FIG. 7 shows the test body clamping device in accordance with FIG. 6 during the clamping process;

FIG. 8 shows the test body clamping device in accordance with FIG. 7 when the clamped position has been reached; and

FIG. 9 shows the test body clamping device according to FIG. 8 after exerting the spring clamping force onto the test body.

### DESCRIPTION OF THE PREFERRED EMBODIMENT

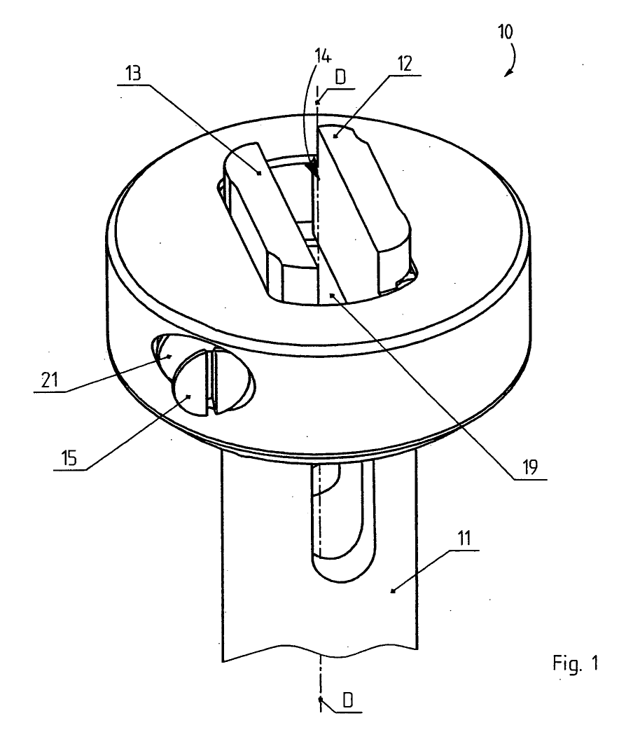

FIG. 1 shows a test body clamping device 10 which is disposed on a shaft 11 of a rotational rheometer. The shaft 11 can be rotated together with the test body clamping device 10 about a longitudinal axis D.

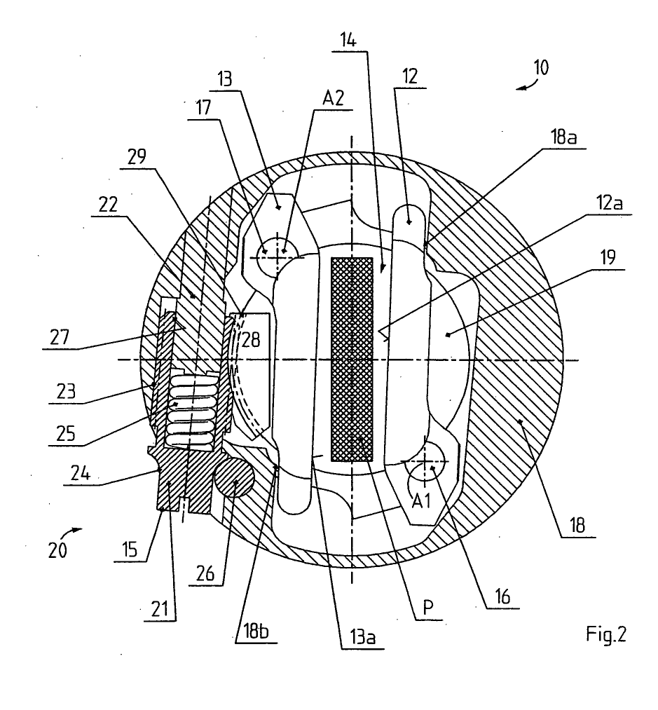

The test body clamping device 10 comprises two clamping jaws 12, 13 between which a receiving space 14 is formed for receiving a test body P (FIG. 2). FIG. 1 shows an adjustment screw 21 having an operating section 15, the rotation of which moves the two clamping jaws 12, 13 towards each other or away from each other, thereby clamping or releasing the test body P.

In FIG. 2, a bottom part 19 is rigidly mounted to the shaft 11 and bears one bearing pin 16 and 17 at each of two locations disposed diametrally opposite relative to the longitudinal axis D. One clamping jaw 12, 13 is rotatably disposed on each bearing pin 16 and 17, such that the clamping jaw 12 on the right in FIG. 2 can be pivoted about an axis of rotation A₁ and the clamping jaw 13 on the left in FIG. 2 can be pivoted about an axis of rotation A₂. The axes of rotation A₁ and A₂ extend parallel to each other and parallel to the longitudinal direction D of the shaft 11 of the rheometer.

The clamping jaws 12, 13 extend substantially parallel to each other, wherein, in particular, their mutually facing clamping surfaces 12a and 13a extend parallel to each other and define a receiving space 14, in which the test body P is loosely inserted, such that its longitudinal axis coincides with the longitudinal axis D of the shaft 11. The test body is thereby supported with its lower side on the bottom part 19.

The bottom part 19 moreover comprises a toothed block 28 which bears a toothed profile 29 on its outer side.

The bottom part 19 and, in particular, the two clamping jaws 12, 13 are surrounded by a drive part in the form of a rotatable drive ring 18, comprising two contact surfaces 18a and 18b which can be brought into abutment with the clamping jaws 12 and 13 on the rear side of the clamping jaws 12 and 13 facing away from the respective clamping surface 12a and 13a, wherein further rotation of the drive ring 18 forces the clamping jaw 12 or 13 to pivot about the respective axis of rotation A₁ or A₂. Since the contact surfaces 18a and 18b seat on a common drive part, i.e. the drive ring 18, the pivot motions of the clamping jaws 12 and 13 are synchronized with respect to each other such that clamping surfaces 12a or 13a remain parallel to each other and symmetrical with respect to the longitudinal axis or axis of rotation D of the shaft 11 of the rheometer in any pivot position of the clamping jaws 12, 13.

The drive ring 18 which is also disposed to be rotatable about the axis of rotation D, supports a cylindrical bearing pin 22, which extends in a substantially tangential direction relative to the axis of rotation D, the bearing pin 22 bearing an adjustment screw 21 which is part of an operating device 20 of the test body clamping device 10. The adjustment screw 21 has a cylindrical basic body having an axial recess or bore 27 via which the adjustment screw 21 is seated on the bearing pin 22 with tight fit but freely displaceable. A helical pressure or clamping spring 25 is disposed within the bore or recess 27, the axial end of which is supported on the bottom of the bore or recess 27 and the opposite end of which can be brought into abutment with the end face of the bearing pin 22. FIG. 2 shows the clamping spring 25 in a relaxed, unloaded state.

The adjustment screw 21 has an outer helical toothing 23, which engages in the toothed profile 29 of the toothed block 28 and permits slight relative axial displacement.

A peripheral depression or annular groove 24 is formed on the end of the adjustment screw 21 facing away from the bearing pin 22, in which a pin-shaped projection 26 of the drive ring 18 engages with play in the longitudinal direction of the adjustment screw 21, wherein the projection 26 abuts the bottom of the annular groove 24.

The function of the test body clamping device 10 will be described in detail below with reference to FIGS. 2 through 5. FIG. 2 shows the initial state, in which the test body P is inserted with play between the parallel oriented clamping jaws 12 and 13. The drive ring 18 does not abut the clamping jaws 12, 13 and the clamping spring 25 is completely relaxed. The clamping jaws 12 and 13 may be pre-tensioned into their open position by springs (not shown).

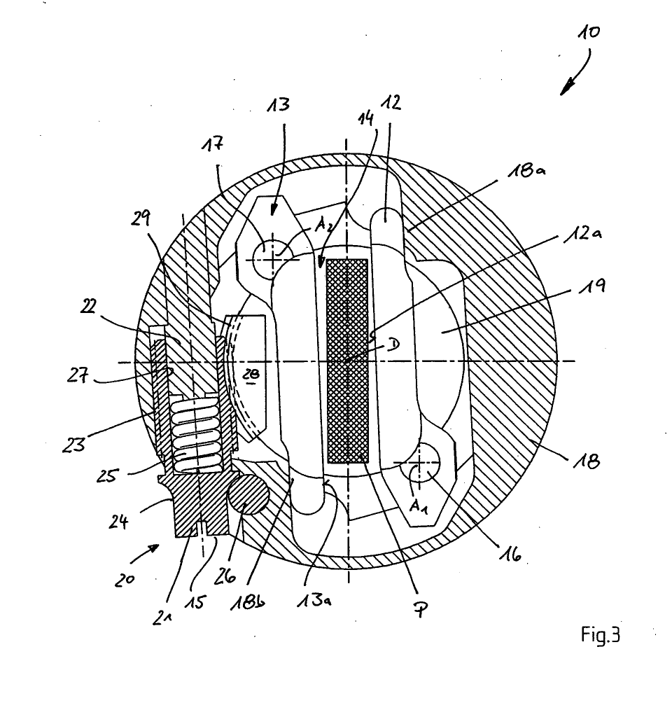

When the adjustment screw 21 is turned, it is axially displaced on the bearing pin 22 until the flank of the annular groove 24 abuts the projection 26 of the drive ring 18. This state is shown in FIG. 2. Further rotation of the adjustment screw 21 produces a rotary motion of the drive ring 18 via abutment of the annular groove 24 and projection 26, the contact surfaces 18a and 18b of the drive ring 18 abutting one free end of each clamping jaw 12, 13, facing away from the axes of rotation A₁ and A₂, and forcing them to pivot, thereby reducing the separation between the clamping surfaces 12a and 13a of the clamping jaws 12 and 13 (FIG. 3). Since the drive ring 18 and the adjustment screw 21 rotate as a unit, the clamping spring 25 initially remains completely relaxed.

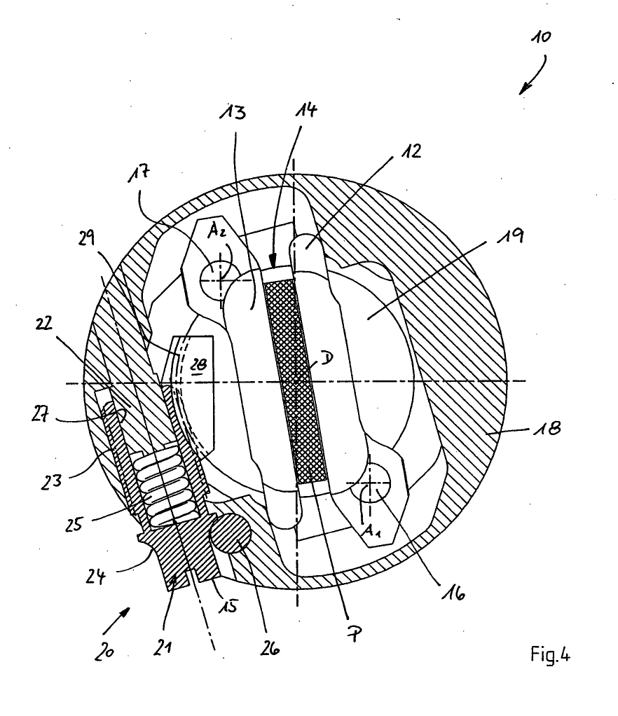

Rotation of the adjustment screw 21 is continued to further rotate the drive ring 18, thereby bringing the clamping surfaces 12a and 13a of the clamping jaws 12 and 13 into abutment with the test body P from opposite sides, clamping it between them. This state is shown in FIG. 4.

The clamping jaws 12 and 13 now firmly abut the test body P, and upon further rotation, the adjustment screw 21 travels away from abutment of its annular groove 24 on the projection 26 of the drive ring 18 towards the bearing pin 22 due to the reaction moment at the location where its outer toothing 23 engages the toothed profile 29.

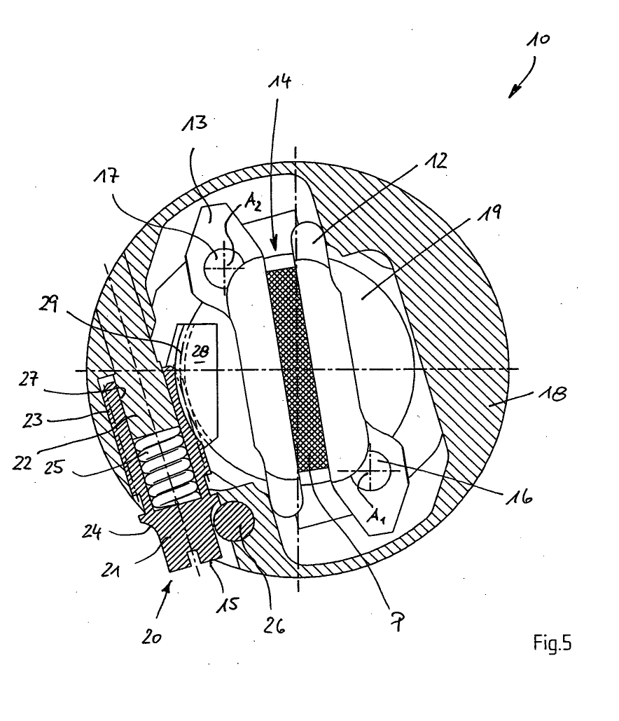

The clamping spring 25 disposed inside the adjustment screw 21 is thereby pressed against the bearing pin 22 and clamped. This state is shown in FIG. 5.

When the clamping force of the clamping jaws 12 and 13 changes during the measurement due to thermal influences on the test body clamping device or the test body to be measured, the clamping spring 25 compensates for the clamping forces on the test body clamped between the clamping jaws, by changing its axial length, i.e. through tension or relaxation, reacting to force changes with approximately the same reaction force. This displacement results from the rotary motion of the drive ring 18 which is effected by opening or closing the clamping jaws 12, 13. This automatic readjustment of the clamping force is possible, since the outer toothing 23 of the adjustment screw 21 is self-locking.

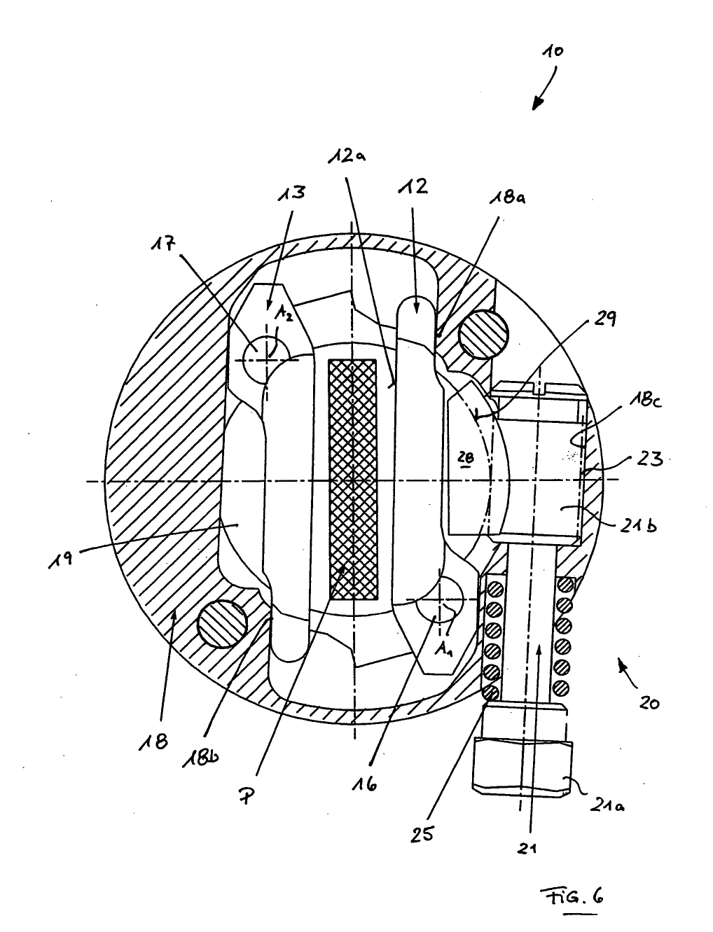

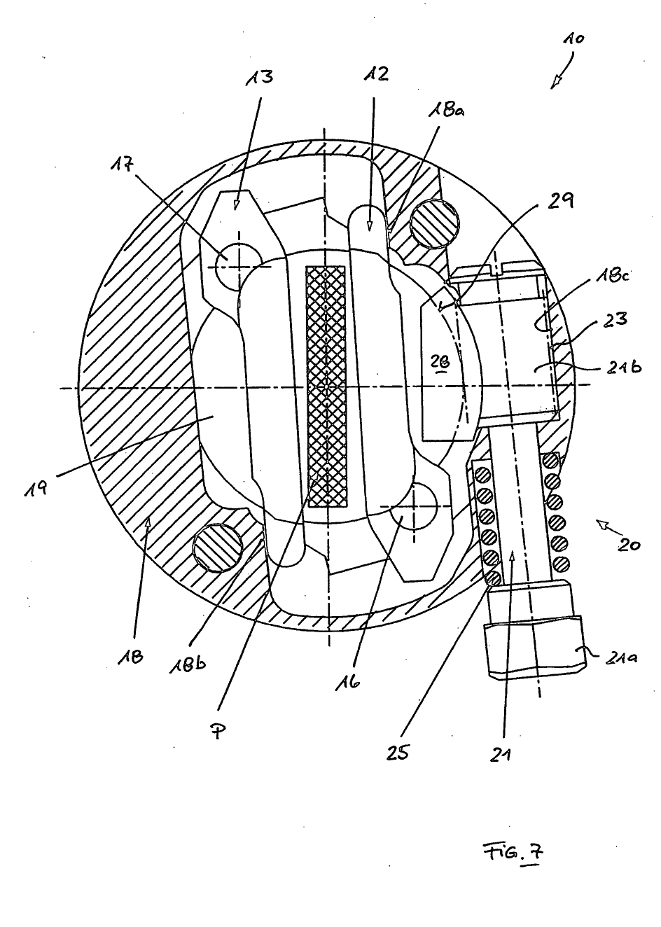

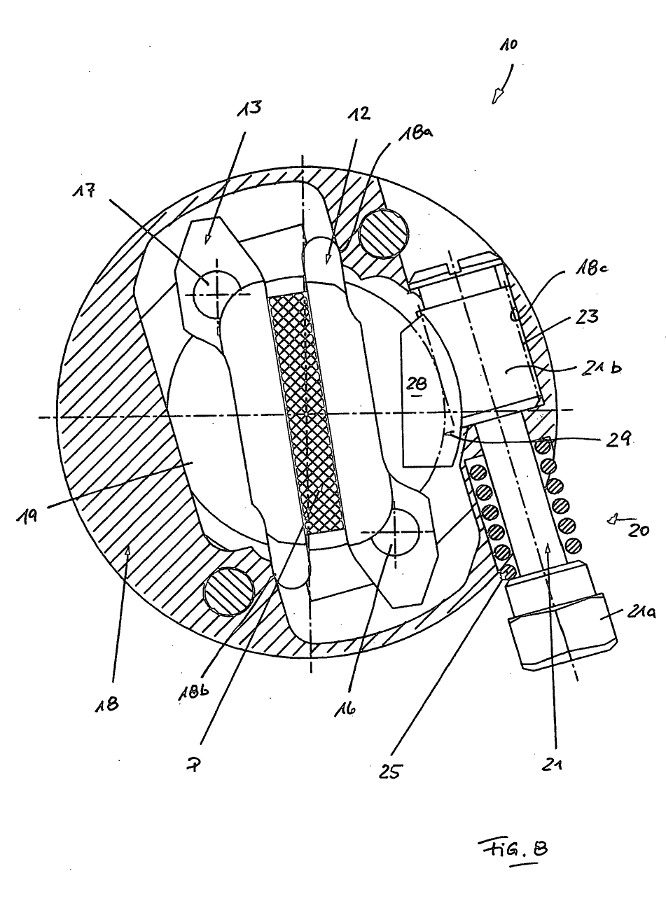

FIGS. 6 through 9 show an alternative design of the test body clamping device 10 which substantially corresponds to constructive designs of the test body clamping device 10 described in connection with FIGS. 1 through 5, wherein identical components have identical reference numerals.

The essential difference of the test body clamping device 10 of FIGS. 6 through 9 concerns the operating device 20. The adjustment screw 21 has a head 21a where the user can apply a tool. A bearing block 21b is formed on the adjustment screw 21 at the end remote from the head 21a and comprises an outer toothing 23 which engages the toothed profile 29 of the toothed block 28 and permits a slight relative axial displacement. The bearing block 21b is seated in a recess 18c of the drive part 18 in such a manner that the adjustment screw 21 can be rotated and slightly axially displaced within the recess 18c.

A helical clamping spring 25 is disposed on the adjustment screw 21 between the head 21a and a contact surface of the drive part 18, which is relaxed and unloaded in the initial state shown in FIG. 6.

The function of the test body clamping device 10 will be explained below with reference to FIGS. 6 through 9. FIG. 6 shows the initial state, wherein the test body P is inserted with play between the clamping jaws 12 and: 13. The drive ring 18 does not yet exert any force on the clamping jaws 12 and 13 and the clamping spring 25 is completely relaxed.

When the clamping screw 21 is turned by a user, the outer thread 23 of the bearing block 21b engages along the toothed profile 29 of the toothed block 28 to rotate the drive ring 18 in an anticlockwise direction (FIG. 6). Rotation of the drive ring 18 causes the contact surfaces 18a and 18b of the drive ring 18 to displace the free ends of the clamping jaws 12 and 13 facing away from the axes of rotation A₁ and A₂, and forces the clamping jaws 12 and 13 to pivot, thereby clamping the test body P between the clamping jaws 12 and 13. Since the drive ring 18 and the adjustment screw 21 rotate as a unit, the clamping spring 25 is still completely relaxed.

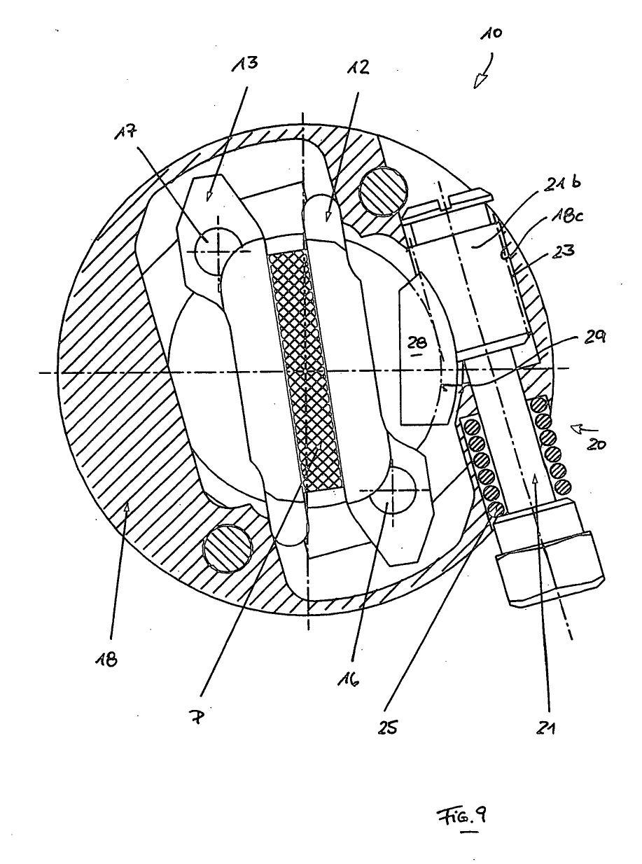

When the test body P is clamped between the clamping jaws 12 and 13, further rotation of the drive ring 18 is not possible. During further rotation of the clamping screw 21, the clamping screw performs an axial motion or displacement relative to the drive ring 18, thereby compressing and tensioning the clamping spring 25. This state is shown in FIG. 9. The drive ring 18 is pressed against the clamping jaws 12 and 13 by the spring force of the clamping spring 25, such that the test body P is clamped between them under elastic pre-tension. As was already mentioned above, this causes the test body to be safely retained between the clamping jaws 12 and 13 during the measurement even when its dimensions change due to temperature-related expansion or shrinkage.

I claim:

1. A device for clamping a test body in a rheometer, the device comprising:
a first jaw disposed to pivot about a first jaw axis, said first jaw having a first jaw clamping surface to engage the test body, said first jaw axis extending parallel to said first jaw clamping surface;
a second jaw disposed to pivot about a second jaw axis, said second jaw having a second jaw clamping surface to engage the test body, said second jaw axis extending parallel to said second jaw clamping surface and parallel to said first jaw axis;
a drive part cooperating with said first and said second jaws to move said first and second jaws towards each other for clamping the test body and away from each other for releasing the test body, the drive part inducing a synchronized pivoting motion of said first and said second jaws; and
a clamping force element structured, dimensioned and disposed to exert a common clamping force on said first and said second jaws in a clamped position of the test body.

2. The device of claim 1, wherein said clamping force element is a clamping spring.

3. The device of claim 1, wherein said clamping force element acts on said first and said second jaws via said drive part.

4. The device of claim 1, wherein said drive part is a rotatably disposed drive ring.

5. The device of claim 1, further comprising an adjustment screw cooperating with said clamping force element.

6. The device of claim 1, wherein said drive part exercises rotational motion through positive engagement when said clamping force element is in a relaxed state.

7. The device of claim 5, wherein said adjustment screw comprises an outer toothing which engages in a fixed toothed profile of the rheometer.

8. The device of claim 7, wherein said outer toothing engages said toothed profile in a self-locking manner.

9. The device of claim 5, wherein said adjustment screw has an inner axial recess with which it seats on a bearing pin of said drive part in such a manner that it can be freely displaced.

10. The device of claim 9, wherein said clamping force element is disposed inside said recess and is supported on said bearing pin.

11. The device of claim 5, wherein said adjustment screw has a peripheral annular groove which cooperates with a projection of said drive part.

12. The device of claim 5, wherein said adjustment screw seats in a recess of said drive part in such a manner that it can be freely displaced.

13. The device of claim 1, wherein said drive part engages end sections of each of said first and said second clamping jaws facing away from said respective first and second jaw axes.

14. The device of claim 1, wherein said first and said second jaw clamping surfaces extend parallel to each other and are disposed symmetrically with respect to an axis of rotation of the rheometer in all pivot positions of said first and said second jaws.
